(19) United States
(12) Patent Application Publication
(10) Pub. No.: US 2022/0168177 A1
(43) Pub. Date: Jun. 2, 2022

(54) Percussion Massager Having Variable and Selectable Stroke Length

(71) Applicant: PlayMakar Inc., Fort Worth, TX (US)

(72) Inventors: Federico G. Vierheller, Fort Worth, TX (US); Michael J. Williams, Colleyville, TX (US); Wesley A. Coleman, N. Richland Hills, TX (US)

(73) Assignee: PlayMakar Inc., Fort Worth, TX (US)

(21) Appl. No.: 17/524,732

(22) Filed: Nov. 11, 2021

Related U.S. Application Data
(60) Provisional application No. 63/164,278, filed on Mar. 22, 2021.
(60) Provisional application No. 63/120,502, filed on Dec. 2, 2020.

(51) Int. Cl. A61H 23/00; A61H 23/02

(52) U.S. Cl. CPC A61H 23/006; A61H 23/0263; A61H 2201/1669; A61H 2201/0153; A61H 2201/1215

(57) ABSTRACT

An adjustable stroke length percussion massage device includes a stroke arm connected to a piston which is connected to a massage tool for providing a massage to a user. The stroke arm is secured to a crank pin of a crank mechanism which includes a rotatably connected crank housing and crank base, the crank pin being movably secured between the crank housing and crank base such that the crank pin moves from a first end to a second end of a sliding groove located in the cam housing when a rotation direction of the single unit is reversed by a motor. When the crank pin is moved from the first end to the second end of the sliding groove, a stroke length of the piston is changed.

### CROSS-REFERENCE TO RELATED APPLICATIONS

The present application claims priority to the following U.S. Provisional applications: Ser. No. 63/164,278 filed Mar. 22, 2021 and Ser. No. 63/120,502 filed Dec. 2, 2020, which are incorporated herein by reference in their entireties.

The following applications are incorporated herein by reference in their entireties: U.S. patent application Ser. No. 17/229,860 entitled Variable Stroke Percussive Massage Device, filed Apr. 13, 2021 and U.S. application Ser. No. 17/508,954 filed on Oct. 22, 2021 entitled Constrained and Repositionable Percussive Massage Device Tool and Tool Receiver, both commonly owned and listing overlapping inventors.

### FIELD OF THE INVENTION

This invention relates to percussion massagers, and more specifically, to a variable stroke length percussive massage device configured as a handheld device that delivers a barrage of short rapid adjustable strokes that penetrate deeper into the muscle tissue.

### BACKGROUND

Percussion massage devices have become increasing popular for home use. Typical percussion massage devices have a massage head that moves back and forth between an extended position and a retracted position. Typically, this distance can range from about 10 mm to about 20 mm and is referred to as the device's stroke length. This movement may occur as a rapid reciprocating motion, such as between about 1700 to about 3400 strokes per minute.

Conventional percussion massage devices have a fixed stroke length, albeit this fixed stroke length can vary from one device to another. Thus, if a user desires a gentler, shorter stroke length on another day, they typically need to own two different percussion massage devices.

Therefore, there is a need for a device that can provide a user percussive massage therapy while allowing a user to change the stroke length in a simple and quick manner. The present invention accomplishes these objectives.

### SUMMARY OF THE INVENTION

In a first embodiment, a percussion massage device having a user selectable stroke length is described. The percussion massage device includes: a stroke arm having a first end connected to a piston at a first end thereof and the stroke arm having a second end secured to a crank pin, the piston further being connected at a second end thereof to at least a first end of a massage tool and the massage tool having a second end thereof for massaging a user; a crank mechanism including the crank pin, a crank housing and a crank base, wherein the crank housing and crank base are connected and rotatable as a single unit, and the crank pin is movably secured between the crank housing and crank base such that the crank pin moves from a first end to a second end of a sliding groove located in the cam housing when a rotation direction of the single unit is reversed by a motor; wherein when the crank pin is moved from the first end to the second end of the sliding groove, a stroke length of the piston is changed from a first predetermined stroke length to a second predetermined stroke length.

In a second embodiment, a percussion massage device having a user selectable stroke length is described. The percussion massage device includes: a massage tool for massaging a user in accordance with a percussive action supplied by a piston; a crank mechanism in mechanical communication with the piston, the crank mechanism including a crank pin, a crank housing and a crank base, wherein the crank housing and crank base are connected and rotatable as a single unit, and the crank pin is movably secured between the crank housing and crank base such that the crank pin moves from a first end to a second end of a sliding groove located in the cam housing when a rotation direction of the single unit is reversed by a motor; wherein when the crank pin is moved from the first end to the second end of the sliding groove, a stroke length of the piston is changed from a first predetermined stroke length to a second predetermined stroke length.

### BRIEF DESCRIPTION OF THE DRAWINGS

Example embodiments will become more fully understood from the detailed description given herein below and the accompanying drawings, wherein like elements are represented by like reference characters, which are given by way of illustration only.

FIG. 1 is a perspective view of a representative percussion massage device which may incorporate the variable stroke length subsystem described herein;

FIGS. 2a, 2b, 2c are exemplary tools which may be uses to deliver the percussion massage to the muscle of the user;

FIGS. 3a, 3b, 3c, 3d, 3e are various views of a variable stroke length subsystem in accordance with a preferred embodiment; and

FIGS. 4a, 4b, 4c, 4d, 4e are various views of particular aspects of the variable stroke length subsystem of FIGS. 3a, 3b, 3c, 3d, 3e.

FIGS. 5a, 5b, 5c are exploded and partial internal views of a representative percussion massage device with various views of a device display in accordance with one or more embodiments.

### DETAILED DESCRIPTION

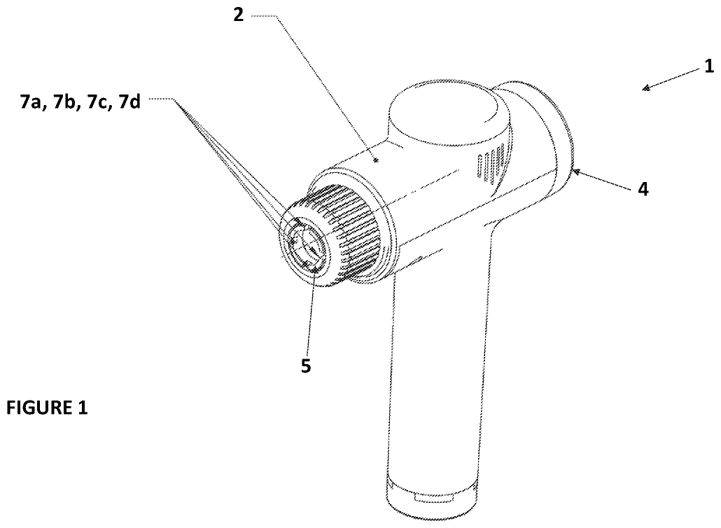

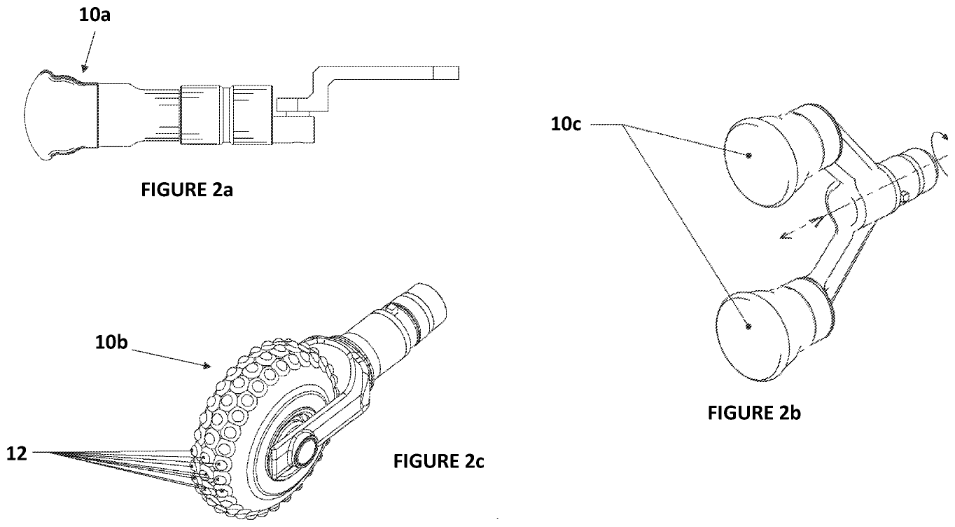

FIG. 1 illustrates an exemplary percussion massage device 1 which may incorporate the variable stroke length subsystem described further herein. The percussion massage device 1 of FIG. 1 receives a massage tool (not shown), which may be one of various configurations, in the tool holder 5 thereof. FIGS. 2a-2c shows examples of tools 10a, 10b, 10c which may be removably attached to tool holder 5 of FIG. 1 in accordance with a key and keyway (see key ways 7a, 7b, 7c, 7d in FIG. 1) attachment system and/or a magnetic attachment system, which are described in U.S. application Ser. No. 17/508,954 which is incorporated herein by reference in its entirety. The tools 10a, 10b, 10c deliver a barrage of short rapid adjustable strokes to the user's muscle tissue in accordance with the variable stroke length subsystem. The tread 12 of FIG. 2c is exemplary and may take on different configurations. Further, the tools may also include exchangeable massage tips, wherein the massage tips having varying shapes, sizes and materials, such that a user may select a massage tip that provides a preferred massage experience.

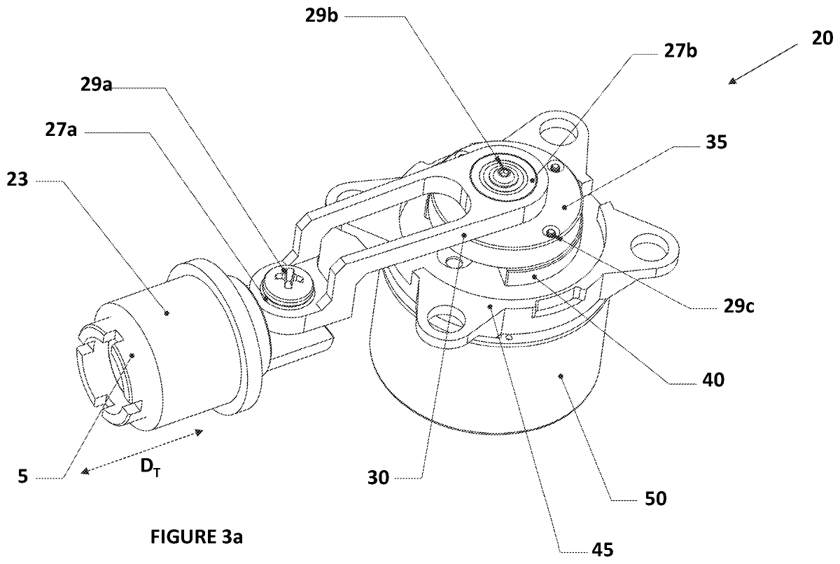

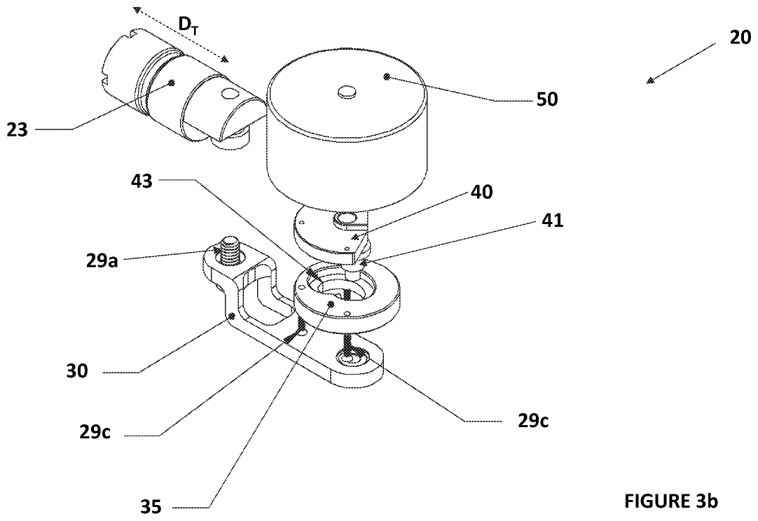

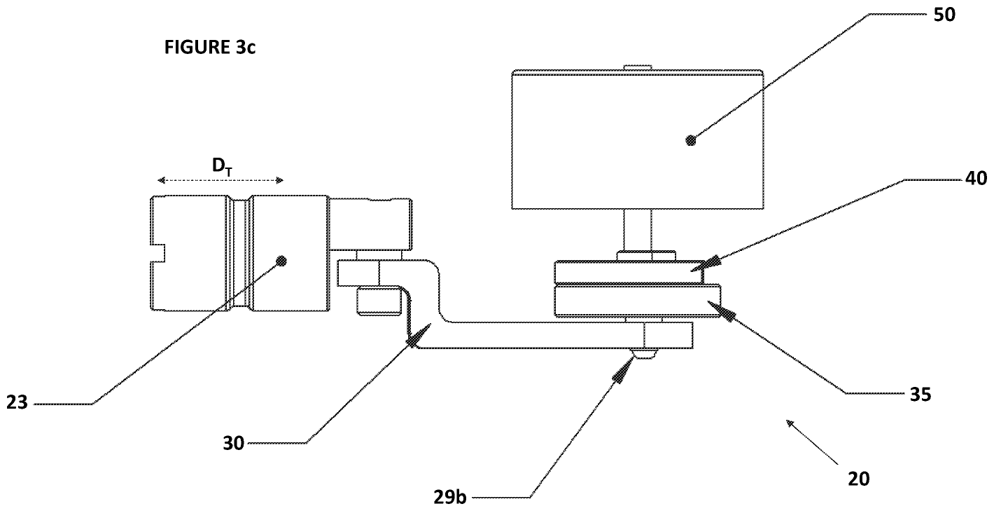

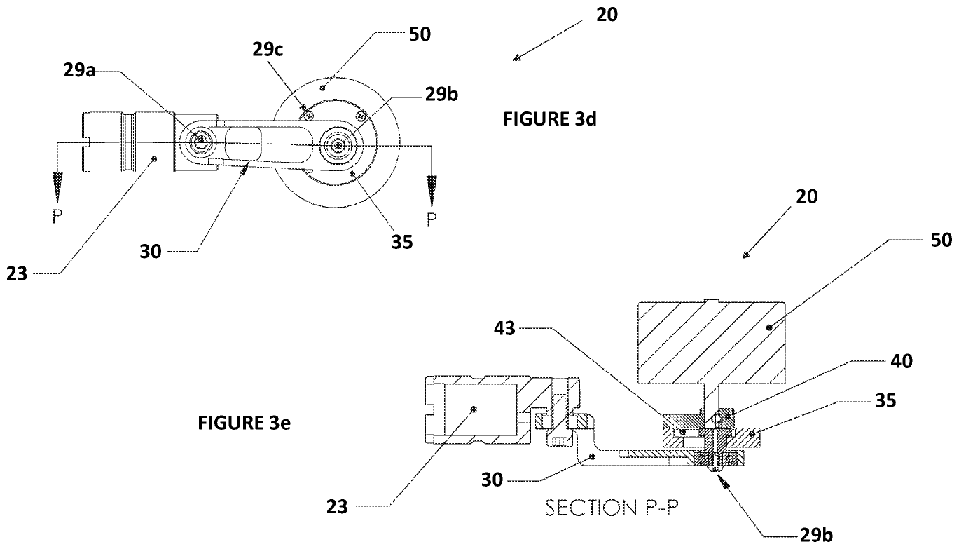

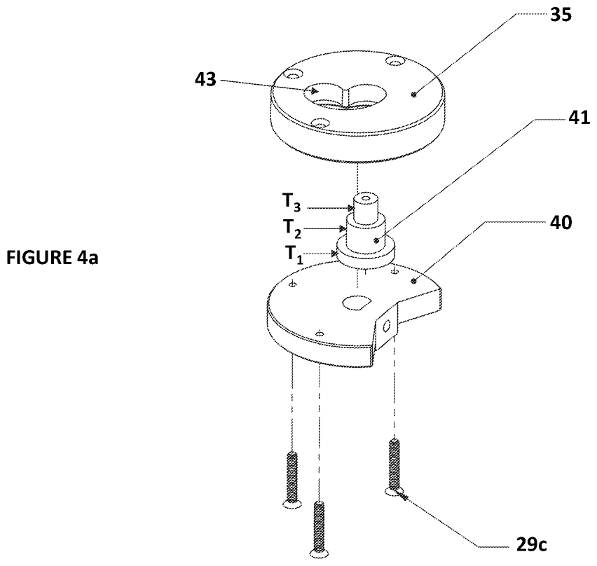

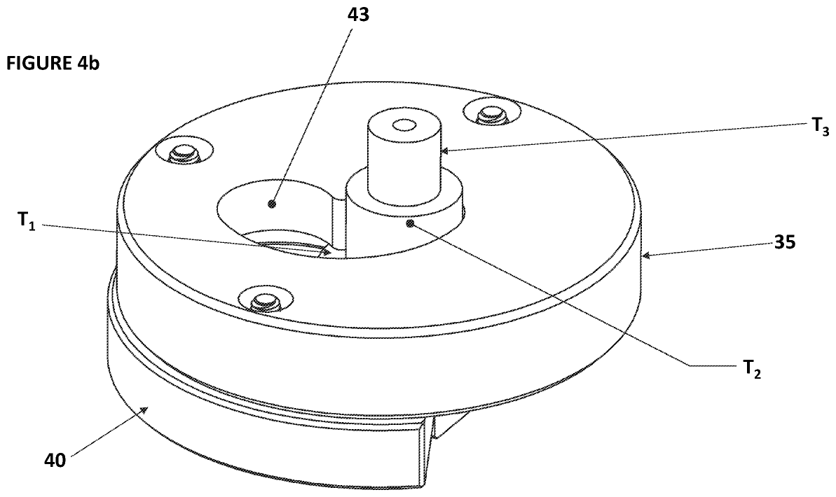

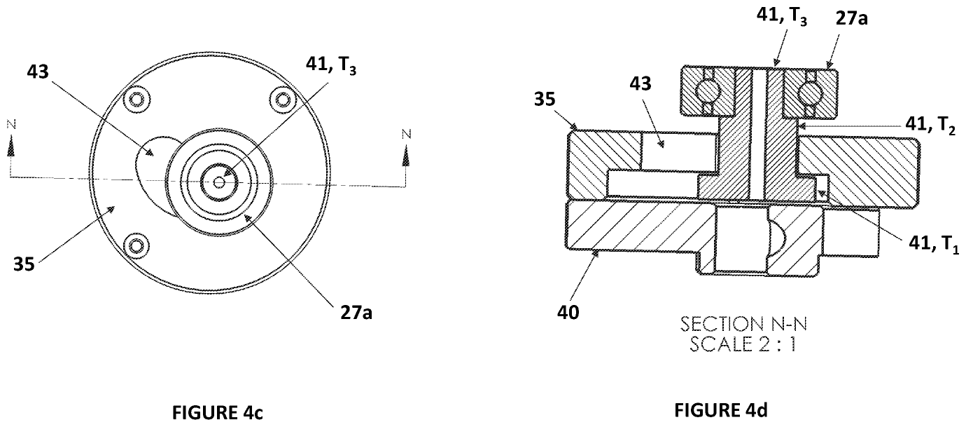

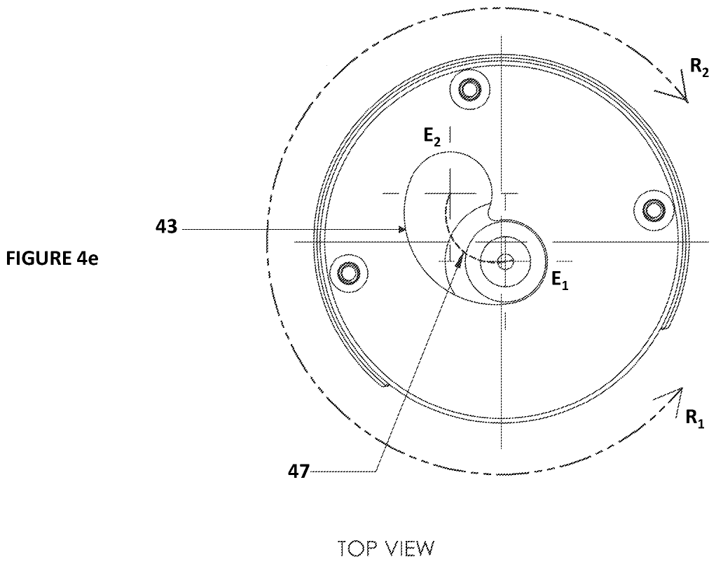

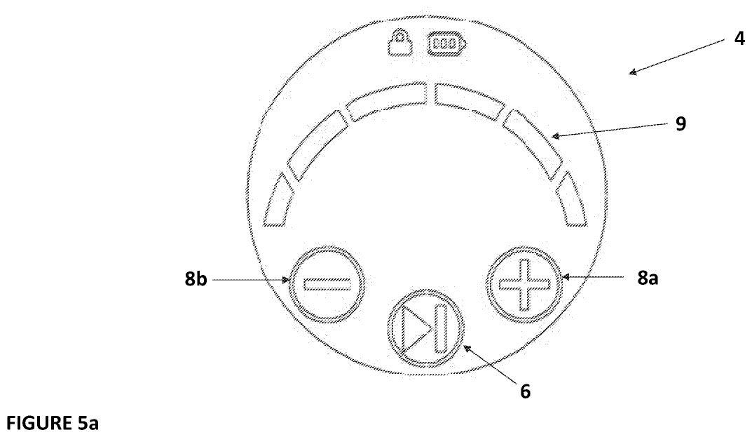

FIGS. 3a, 3b, 3c, 3d and 3e illustrate various views and features of an exemplary variable stroke length subsystem 20 in accordance with a preferred embodiment. As shown in top perspective view FIG. 3a, tool holder/slider 5 which is responsive to the reciprocation motion of piston 23 which is attached to a first end of a connecting rod 30 at ball bearing 27a and fastener/retainer (e.g., screw) 29a. A second end of connecting rod 30 is connected to a crank housing 35 at ball bearing 27b and fastener/retainer 29b. Crank housing 35 is attached to crank base 40 via multiple fasteners 29c. Motor 50, including motor base 45, drives the crank base 40, which also rotates crank housing 35, resulting in slidable movement of crank pin 41 (FIG. 4b) which is discussed in detail herein. The motor 50 is preferably a reversible direction motor. The piston 23 oscillates in the direction of travel (DT) at, e.g., 5000 rpm, in accordance with the crank shaft mechanism described above. In certain embodiments, one skilled in art will appreciate that the tool holder/slider 5 may further include a sliding bearing and a vibration isolator. The vibration isolator may be a dumper made of a low durometer elastomeric material working to absolve vibrations between the slider 5 and the device housing 2.

FIG. 3b is a bottom exploded perspective view of the exemplary variable stroke length subsystem 20. In this view, the opening or sliding groove 43 of the crank housing 35 can be seen. As discussed herein, crank pin 41 is slidably held and movable within the opening 43. In a preferred embodiment, the sliding groove has a non-linear shape, preferably an arc-shape, having a radius of curvature that is greater than a radius of curvature of the crank housing 35 and crank base 40, which rotate together as a single unit.

FIG. 3c is a side view of a variable stroke length subsystem 20 in accordance with a preferred embodiment. FIG. 3d is a top view of a variable stroke length subsystem 20 in accordance with a preferred embodiment, with FIG. 3e showing internal side view in accordance with section P-P.

FIGS. 4a, 4b, 4c, 4d, 4e illustrate various views of crank housing 35, crank base 40, fasteners 29c, and crank pin 41 inserted into sliding groove 43. In FIG. 4a, the multi-tiered pin 41 configuration can be seen, wherein the bottom tier T₁ has the widest diameter, middle tier T₂ has a smaller diameter than tier T₁ and tier T₃ has the smallest diameter. Crank pin 41 is created with a hard material, such as, but not limited to aluminum.

In FIG. 4b, an operational (unexploded) view of the crank pin 41 sandwiched between the crank housing 35 and crank base 40 is illustrated. As shown, tier T₁ of crank pin 41 sits below the sliding groove 43 which is narrower in width as compared to the diameter of T₁ and T₂ fits slidably within sliding groove 43. And T₃ protrudes out of crank housing 35 and is secured to connecting rod (not shown). The crank pin 41 will be sliding to the sliding groove 43 as a slip fit fitting.

FIG. 4c is a top view of crank housing 35 with top of tier T₃ of crank pin 41 showing (without fastener 29a) and bearing 27a illustrated (without connecting rod). By excluding the connecting rod from the view, a portion of sliding groove 43 is also shown. FIG. 4d is the cross-sectional view.

Referring to FIG. 4e, sliding groove 43 has two ends E₁ and E₂ which are located at different distances from the center of rotation of the crank housing. In operation, depending on the direction of rotation R₁ (counter clockwise) or R₂ (clockwise) of the crank housing 35 driven by motor 50 (not shown), crank pin 41 slides between the two ends of the sliding groove 43 along sliding trajectory 47, where the distance of travel is proportional to the radial distance to the groove from the axis to the connecting rod (FIG. 4a). If direction of rotation is R₁, the crank pin 41 engages with end E₂ which is further from the center of rotation; if direction of rotation is R₂, the crank pin 41 engages with end E₁ on the which is closer to the center of rotation.

In the preferred embodiment, E₁ engages crank pin 41 at center of rotation bottom end at 4 mm+/−2 and E₂ engages crank pin 41 at the center of rotation top end at 10 mm+/−2. These positions result in a variable stroke of 4 mm to 10 mm (short stroke) 10 mm to 22 mm (long stroke). A change in rotation direction of the crank base 40 causes crank housing 35 to change direction, which causes crank pin 41 to slide from one end of the sliding groove 43 to the other and consequently changes the variable stroke length of the piston 25.

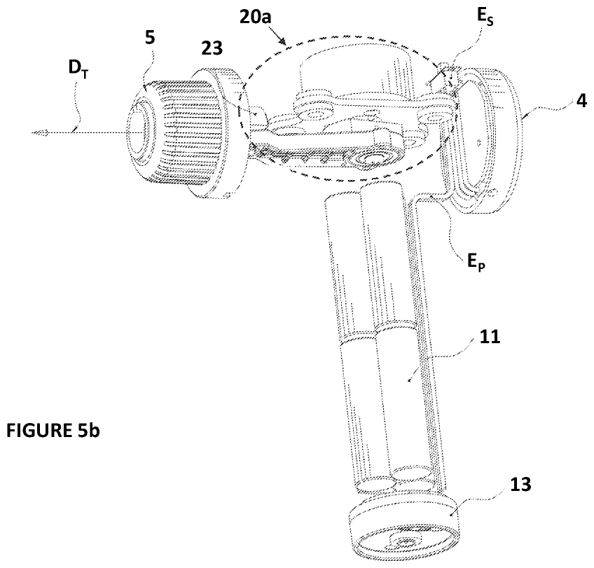

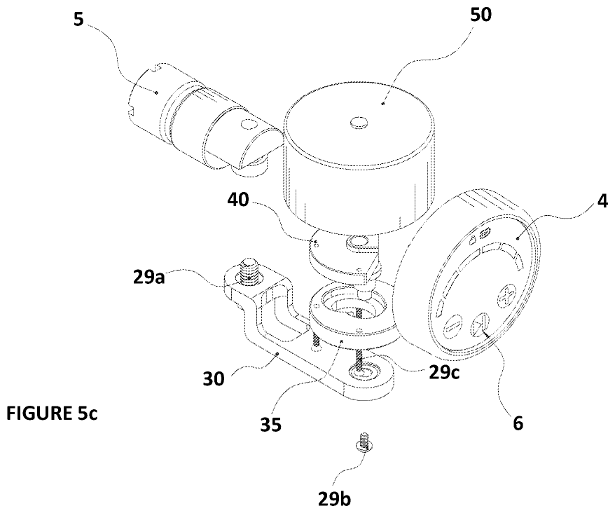

Referring to FIGS. 5a to 5c, a user may select a preferred stroke length from two available stroke lengths (short or long) using a tactile direction switch 6 provided on the display 4. For visual indication, the switch is illuminated and changes from a first to a second color depending on the selected stroke length. The user may also adjust speed of the stroke to a desired level using increase and decrease buttons 8a, 8b, with a visual indication of speed level indicated on the lighted display 9.

In FIG. 5b, internal electrical connections which power the display E_{P} and facilitate the switching E_{S} are illustrated, along with exemplary rechargeable battery component 11 and power base 13. The switching subsystem 20A of FIG. 5b is described in application Ser. No. 17/229,860 and may be replaced with switching subsystem 20B described herein above in detail and shown in relation to display 4 in FIG. 5c. Additional description of exemplary switch configurations and internal details which are usable with the embodiments described herein are disclosed in application Ser. No. 17/229,860 which is incorporated herein by reference.

The embodiment set forth above is exemplary. Unless otherwise defined, all technical and scientific terms used herein have the same meaning as commonly understood by one of ordinary skill in the art to which the embodiment belongs. The variable stroke percussive massage device may be embodied in other specific forms without departing from the spirit or essential attributes thereof, and it is therefore desired that the present embodiment be considered in all respects as illustrative and not restrictive.

1. A percussion massage device having a user selectable stroke length, comprising:
a stroke arm having a first end connected to a piston at a first end thereof and the stroke arm having a second end secured to a crank pin, the piston further being connected at a second end thereof to at least a first end of a massage tool and the massage tool having a second end thereof for massaging a user;
a crank mechanism including the crank pin, a crank housing and a crank base, wherein the crank housing and crank base are connected and rotatable as a single unit, and the crank pin is movably secured between the crank housing and crank base such that the crank pin moves from a first end to a second end of a sliding groove located in the cam housing when a rotation direction of the single unit is reversed by a motor;
wherein when the crank pin is moved from the first end to the second end of the sliding groove, a stroke length of the piston is changed from a first predetermined stroke length to a second predetermined stroke length.

2. The percussion massage device having a user selectable stroke length of claim 1, wherein when the crank pin is at a first end of the sliding groove, the crank pin is in a first distance range from a rotation axis of the single unit and when the crank pin is at a second end of the sliding groove, the crank pin is in a second distance range from the rotation axis of the single unit.

3. The percussion massage device having a user selectable stroke length of claim 2, wherein the first distance range is about 2 mm to about 5 mm and the second distance range is from about 5 mm to about 11 mm, providing a first predetermined stroke length when in the first distance range from about 5 mm to about 10 mm when the pin is at the first end of the sliding groove and a second predetermined stroke length when in the second distance range from about 10 to about 22 mm when the pin is at the second end of the sliding groove.

4. The percussion massage device having a user selectable stroke length of claim 1, wherein the sliding groove is non-linear.

5. The percussion massage device having a user selectable stroke length of claim 4, wherein the sliding groove is arc-shaped, having a radius of curvature greater than a radius of curvature the single unit during rotation thereof.

6. The percussion massage device having a user selectable stroke length of claim 1, wherein the crank pin includes three tiers.

7. The percussion massage device having a user selectable stroke length of claim 1, including a switch located on a display of the percussion massage device, wherein the switch enables selection by the user of the first or second predetermined stroke length range.

8. A percussion massage device having a user selectable stroke length, comprising:
a massage tool for massaging a user in accordance with a percussive action supplied by a piston;
a crank mechanism in mechanical communication with the piston, the crank mechanism including a crank pin, a crank housing and a crank base, wherein the crank housing and crank base are connected and rotatable as a single unit, and the crank pin is movably secured between the crank housing and crank base such that the crank pin moves from a first end to a second end of a sliding groove located in the cam housing when a rotation direction of the single unit is reversed by a motor;
wherein when the crank pin is moved from the first end to the second end of the sliding groove, a stroke length of the piston is changed from a first predetermined stroke length to a second predetermined stroke length.

9. The percussion massage device having a user selectable stroke length of claim 8, wherein when the crank pin is at a first end of the sliding groove, the crank pin is in a first distance range from a rotation axis of the single unit and when the crank pin is at a second end of the sliding groove, the crank pin is in a second distance range from the rotation axis of the single unit.

10. The percussion massage device having a user selectable stroke length of claim 9, wherein the first distance range is about 2 mm to about 5 mm and the second distance range is from about 5 mm to about 11 mm, providing a first predetermined stroke length when in the first distance range from about 5 mm to about 10 mm when the pin is at the first end of the sliding groove and a second predetermined stroke length when in the second distance range from about 10 to about 22 mm when the pin is at the second end of the sliding groove.

11. The percussion massage device having a user selectable stroke length of claim 8, wherein the sliding groove is non-linear.

12. The percussion massage device having a user selectable stroke length of claim 11, wherein the sliding groove is arc-shaped, having a radius of curvature greater than a radius of curvature the single unit during rotation thereof.

13. The percussion massage device having a user selectable stroke length of claim 8, wherein the crank pin includes three tiers.

14. The percussion massage device having a user selectable stroke length of claim 8, including a switch located on a display of the percussion massage device, wherein the switch enables selection by the user of the first or second predetermined stroke length range.
